(19) United States
(12) Patent Application Publication
(10) Pub. No.: US 2023/0314808 A1
(43) Pub. Date: Oct. 5, 2023

(54) Systems With Displays and Sensor-Hiding Structures

(71) Applicant: Apple Inc., Cupertino, CA (US)

(72) Inventors: Jeffrey C. Olson, San Francisco, CA (US); Anthony S. Montevirgen, Redwood City, CA (US); David A. Schmuck, Raymore, MO (US); Divakar Singamsetty, San Jose, CA (US); Edward S. Huo, Sunnyvale, CA (US); Jason L. Slupeiks, Sunnyvale, CA (US); Jeremy C. Franklin, San Francisco, CA (US); Ritu Shah, Sunnyvale, CA (US); Timothy Y. Chang, Campbell, CA (US); Yamile Pariente Monalli, Sunny Isles Beach, FL (US); Jason C. Sauers, Sunnyvale, CA (US)

(21) Appl. No.: 18/178,870

(22) Filed: Mar. 6, 2023

Related U.S. Application Data
(63) Continuation of application No. PCT/US2021/049441, filed on Sep. 8, 2021.
(60) Provisional application No. 63/081,225, filed on Sep. 21, 2020.

(51) Int. Cl. G02B 27/01

(52) U.S. Cl. CPC G02B 27/0172; G02B 27/0176; G02B 27/0189; G02B 2027/0192; G02B 2027/014

(57) ABSTRACT

A head-mounted device may have a head-mounted support structure. Rear-facing displays may present images to eye boxes at the rear of the head-mounted support structure. A forward-facing publicly viewable display may be supported on a front side of the head-mounted support structure facing away from the rear-facing displays. The forward-facing display may have pixels that form an active area in which images are displayed and may have a ring-shaped inactive border area that surrounds the pixels. A cosmetic covering structure such as ring-shaped shroud member may overlap optical components in the inactive border area. The optical components may be received within through-hole openings in the cosmetic covering structure and/or may operate through transparent portions of the cosmetic covering structure.

This application is a continuation of international patent application No. PCT/US2021/049441, filed Sep. 8, 2021, which claims priority to U.S. provisional patent application No. 63/081,225, filed Sep. 21, 2020, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have input-output components. The input-output components may include components such as displays and sensors.

### SUMMARY

A head-mounted device may have a head-mounted support structure. Rear-facing displays may present images to eye boxes at the rear of the head-mounted support structure. A forward-facing publicly viewable display may be supported on a front side of the head-mounted support structure facing away from the rear-facing displays.

The forward-facing display may have pixels that form an active area in which images are displayed and may have a ring-shaped inactive area that surrounds the pixels. A display cover layer may overlap the active and inactive areas.

Optical components may operate through the cover layer in the inactive area. The optical components may include a flicker sensor, an ambient light sensor, cameras, three-dimensional image sensors such as structured light three-dimensional sensors and a time-of-flight three-dimensional image sensor, and an infrared illumination system to provide infrared illumination for tracking cameras in dim ambient lighting conditions.

A cosmetic covering structure such as ring-shaped shroud may overlap optical components in the inactive area. The ring-shaped shroud may be mounted adjacent to the display cover layer in the inactive area.

The optical components may be received within through-hole openings in the shroud and/or may operate through transparent portions of the shroud. The transparent portions may be formed from polymer material in the shroud, from window members such as glass members that are inserted into window openings in the shroud, and/or from other transparent structures. A coating may be formed on portions of the shroud that overlap the optical components to help hide the overlapped components from view while allowing the components to operate satisfactorily.

### BRIEF DESCRIPTION OF THE DRAWINGS

FIG. 1 is a side view of an illustrative electronic device such as a head-mounted device in accordance with an embodiment.

FIG. 2 is schematic diagram of an illustrative system with an electronic device in accordance with an embodiment.

FIG. 3 is a front view of an illustrative head-mounted device in accordance with an embodiment.

FIG. 4 is a front view of an illustrative shroud in accordance with an embodiment.

FIG. 5 is a front view of a portion of an illustrative shroud with a curved periphery in accordance with an embodiment.

FIG. 6 is a front view of a portion of an illustrative forward-facing display in accordance with an embodiment.

FIG. 7 is a cross-sectional top view of a portion of an illustrative display in accordance with an embodiment.

FIG. 8 is a cross-sectional top view of a portion of an illustrative head-mounted device with a display and shroud in accordance with an embodiment.

FIG. 9 is a cross-sectional side view of a portion of an illustrative shroud with a through-hole opening to accommodate an optical component in accordance with an embodiment.

FIG. 10 is a cross-sectional side view of a portion of an illustrative shroud with a window member in a through-hole opening in accordance with an embodiment.

FIG. 11 is a cross-sectional side view of a portion of a head-mounted device with a shroud covering a display in accordance with an embodiment.

FIG. 12 is a cross-sectional side view of an illustrative head-mounted device optical component mounting arrangement with an optical component window coating in accordance with an embodiment.

FIG. 13 is a cross-sectional side view of an illustrative head-mounted device optical component mounting arrangement using shroud through-hole openings in accordance with an embodiment.

FIG. 14 is a cross-sectional side view of an illustrative head-mounted device optical component mounting arrangement with a window formed from a transparent window member such as a layer of glass or clear polymer with a coating in accordance with an embodiment.

### DETAILED DESCRIPTION

A head-mounted device may include a head-mounted support structure that allows the device to be worn on the head of a user. The head-mounted device may have displays that are supported by the head-mounted support structure for presenting a user with visual content. The displays may include rear-facing displays that present images to eye boxes at the rear of the head-mounted support structure. The displays may also include a forward-facing display. The forward-facing display may be mounted to the front of the head-mounted support structure and may be viewed by the user when the head-mounted device is not being worn on the user's head. The forward-facing display, which may sometimes be referred to as a publicly viewable display, may also be viewable by other people in the vicinity of the head-mounted device.

Optical components such as image sensors and other light sensors may be provided in the head-mounted device. In an illustrative configuration, optical components are mounted under peripheral portions of a display cover layer that protects the forward-facing display.

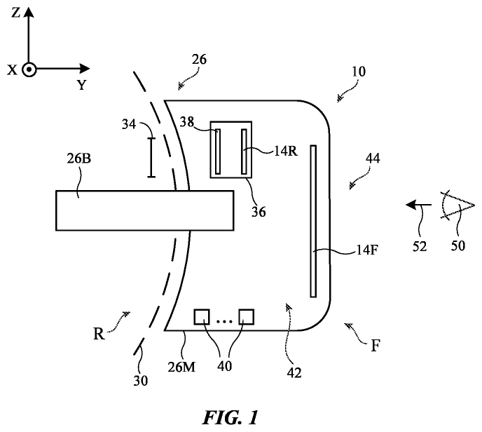

FIG. 1 is a side view of an illustrative head-mounted electronic device. As shown in FIG. 1, head-mounted device 10 may include head-mounted support structure 26. Support structure 26 may have walls or other structures that separate an interior region of device 10 such as interior region 42 from an exterior region surrounding device 10 such as exterior region 44. Electrical components 40 (e.g., integrated circuits, sensors, control circuitry, light-emitting diodes, lasers, and other light-emitting devices, other control circuits and input-output devices, etc.) may be mounted on printed circuits and/or other structures within device 10 (e.g., in interior region 42).

To present a user with images for viewing from eye boxes such as eye box 34, device 10 may include rear-facing displays such as display 14R and lenses such as lens 38. These components may be mounted in optical modules such as optical module 36 (e.g., a lens barrel) to form respective left and right optical systems. There may be, for example, a left rear-facing display for presenting an image through a left lens to a user's left eye in a left eye box and a right rear-facing display for presenting an image to a user's right eye in a right eye box. The user's eyes are located in eye boxes 34 at rear side R of device 10 when structure 26 rests against the outer surface (face surface 30) of the user's face.

Support structure 26 may include a main support structure such as main housing portion 26M (sometimes referred to as a main portion or housing). Main housing portion 26M may extend from front side F of device 10 to opposing rear side R of device 10. On rear side R, main housing portion 26M may have cushioned structures to enhance user comfort as portion 26M rests against face surface 30. If desired, support structure 26 may include optional head straps such as strap 26B and/or other structures that allow device 10 to be worn on a head of a user.

Device 10 may have a publicly viewable front-facing display such as display 14F that is mounted on front side F of main housing portion 26M. Display 14F may be viewable to the user when the user is not wearing device 10 and/or may be viewable by others in the vicinity of device 10. Display 14F may, as an example, be visible on front side F of device 10 by an external viewer such as viewer 50 who is viewing device 10 in direction 52.

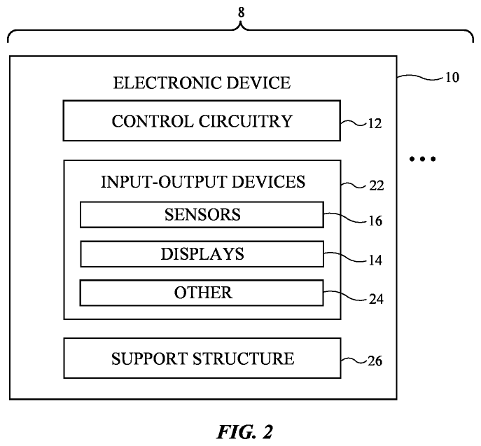

A schematic diagram of an illustrative system that may include a head-mounted device is shown in FIG. 2. As shown in FIG. 2, system 8 may have one or more electronic devices 10. Devices 10 may include a head-mounted device (e.g., device 10 of FIG. 1), accessories such as controllers and headphones, computing equipment (e.g., a cellular telephone, tablet computer, laptop computer, desktop computer, and/or remote computing equipment that supplies content to a head-mounted device), and/or other devices that communicate with each other.

Each electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of device 10) may be used to support communication between the electronic devices. For example, one electronic device may transmit video data, audio data, control signals, and/or other data to another electronic device in system 8. Electronic devices in system 8 may use wired and/or wireless communications circuitry to communicate through one or more communications networks (e.g., the Internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Each device 10 in system 8 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 2, input-output devices 22 may include one or more displays such as displays 14. Displays 14 may include rear facing displays such as display 14R of FIG. 1. Device 10 may, for example, include left and right components such as left and right scanning mirror display devices or other image projectors, liquid-crystal-on-silicon display devices, digital mirror devices, or other reflective display devices, left and right display panels based on light-emitting diode pixel arrays (e.g., thin-film organic light-emitting displays with polymer or semiconductor substrates such as silicon substrates or display devices based on pixel arrays formed from crystalline semiconductor light-emitting diode dies), liquid crystal display panels, and/or or other left and right display devices that provide images to left and right eye boxes for viewing by the user's left and right eyes, respectively. Display components such as these (e.g., a thin-film organic light-emitting display with a flexible polymer substrate or a display based on a pixel array formed from crystalline semiconductor light-emitting diode dies on a flexible substrate) may also be used in forming a forward-facing display for device 10 such as forward-facing display 14F of FIG. 1 (sometimes referred to as a front-facing display, front display, or publicly viewable display).

During operation, displays 14 (e.g., displays 14R and/or 14F) may be used to display visual content for a user of device 10 (e.g., still and/or moving images including pictures and pass-through video from camera sensors, text, graphics, movies, games, and/or other visual content). The content that is presented on displays 14 may, for example, include virtual objects and other content that is provided to displays 14 by control circuitry 12. This virtual content may sometimes be referred to as computer-generated content. Computer-generated content may be displayed in the absence of real-world content or may be combined with real-world content. In some configurations, a real-world image may be captured by a camera (e.g., a forward-facing camera, sometimes referred to as a front-facing camera) and computer-generated content may be electronically overlaid on portions of the real-world image (e.g., when device 10 is a pair of virtual reality goggles).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from dots or other light spots that are produced when a target is illuminated by the beams of light, binocular three-dimensional image sensors that gather three-dimensional images using two or more cameras in a binocular imaging arrangement, three-dimensional lidar (light detection and ranging) sensors, sometimes referred to as time-of-flight cameras or three-dimensional time-of-flight cameras, three-dimensional radio-frequency sensors, or other sensors that gather three-dimensional image data), cameras (e.g., two-dimensional infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors (e.g., strain gauges, capacitive force sensors, resistive force sensors, etc.), sensors such as contact sensors based on switches, gas sensors, pressure sensors, moisture sensors, magnetic sensors, audio sensors (microphones), ambient light sensors, flicker sensors that gather temporal information on ambient lighting conditions such as the presence of a time-varying ambient light intensity associated with artificial lighting, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors.

User input and other information may be gathered using sensors and other input devices in input-output devices 22. If desired, input-output devices 22 may include other devices 24 such as haptic output devices (e.g., vibrating components), light-emitting diodes, lasers, and other light sources (e.g., light-emitting devices that emit light that illuminates the environment surrounding device 10 when ambient light levels are low), speakers such as ear speakers for producing audio output, circuits for receiving wireless power, circuits for transmitting power wirelessly to other devices, batteries and other energy storage devices (e.g., capacitors), joysticks, buttons, and/or other components.

As described in connection with FIG. 1, electronic device 10 may have head-mounted support structures such as head-mounted support structure 26 (e.g., head-mounted housing structures such as housing walls, straps, etc.). The head-mounted support structure may be configured to be worn on a head of a user (e.g., against the user's face covering the user's eyes) during operation of device 10 and may support displays 14, sensors 16, other components 24, other input-output devices 22, and control circuitry 12 (see, e.g., components 40 and optical module 36 of FIG. 1).

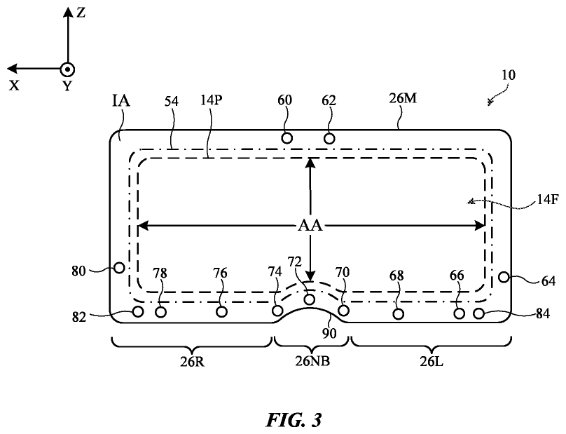

FIG. 3 is a front view of device 10 in an illustrative configuration in which device 10 has a publicly viewable display such as forward-facing display 14F. As shown in FIG. 3, support structure 26M of device 10 may have right and left portions such as portions 26R and 26L that are coupled by an interposed nose bridge portion such as portion 26NB. Portion 26NB may have a curved exterior surface such as nose bridge surface 90 that is configured to receive and rest upon a user's nose to help support main housing portion 26M on the head of the user.

Display 14F may have an active area such as active area AA that is configured to display images and an inactive area IA that does not display images. The outline of active area AA may be rectangular, rectangular with rounded corners, may have teardrop shaped portions on the left and right sides of device 10, may have a shape with straight edges, a shape with curved edges, a shape with a peripheral edge that has both straight and curved portions, and/or other suitable outlines. As shown in FIG. 3, active area AA may have a curved recessed portion at nose bridge portion 26NB of main housing portion 26. The presence of the nose-shaped recess in active area AA may help fit active area AA within the available space of housing portion 26M without overly limiting the size of active area AA.

Active area AA contains an array of pixels. The pixels may be, for example, light-emitting diode pixels formed from thin-film organic light-emitting diodes or crystalline semiconductor light-emitting diode dies (sometimes referred to as micro-light-emitting diodes) on a flexible display panel substrate. Configurations in which display 14F uses other display technologies may also be used, if desired. Illustrative arrangements in which display 14 is formed from a light-emitting diode display such as an organic light-emitting diode display that is formed on a flexible substrate (e.g., a substrate formed from a bendable layer of polyimide or a sheet of other flexible polymer) may sometimes be described herein as an example. The pixels of active area AA may be formed on a display device such as display panel 14P of FIG. 3 (e.g., a flexible organic light-emitting diode display panel). In some configurations, the outline of active area AA (and, if desired, panel 14P) may have a peripheral edge that contains straight segments or a combination of straight and curved segments. Configurations in which the entire outline of active area AA (and optionally panel 14P) is characterized by a curved peripheral edge may also be used.

Display 14F may have an inactive area such as inactive area IA that is free of pixels and that does not display images. Inactive area IA may form an inactive border region that runs along one more portions of the peripheral edge of active area AA. In the illustrative configuration of FIG. 3, inactive area IA has a ring shape that surrounds active area AA and forms an inactive border. In this type of arrangement, the width of inactive area IA may be relatively constant and the inner and outer edges of area IA may be characterized by straight and/or curved segments or may be curved along their entire lengths. For example, the outer edge of area IA (e.g., the periphery of display 14F) may have a curved outline that runs parallel to the curved edge of active area AA.

In some configurations, device 10 may operate with other devices in system 8 (e.g., wireless controllers and other accessories). These accessories may have magnetic sensors that sense the direction and intensity of magnetic fields. Device 10 may have one or more electromagnets configured to emit a magnetic field. The magnetic field can be measured by the wireless accessories near device 10, so that the accessories can determine their orientation and position relative to device 10. This allows the accessories to wirelessly provide device 10 with real-time information on their current position, orientation, and movement so that the accessories can serve as wireless controllers. The accessories may include wearable devices, handled devices, and other input devices.

In an illustrative configuration, device 10 may have a coil such as illustrative coil 54 that runs around the perimeter of display 14F (e.g., under inactive area IA or other portion of display 14F). Coil 54 may have any suitable number of turns (e.g., 1-10, at least 2, at least 5, at least 10, 10-50, fewer than 100, fewer than 25, fewer than 6, etc.). These turns may be formed from metal traces on a substrate, may be formed from wire, and/or may be formed from other conductive lines. During operation, control circuitry 12 may supply coil 54 with an alternating-current (AC) drive signal. The drive signal may have a frequency of at least 1 kHz, at least 10 kHz, at least 100 kHz, at least 1 MHz, less than 10 MHz, less than 3 MHz, less than 300 kHz, or less than 30 kHz (as examples). As AC current flows through coil 54, a corresponding magnetic field is produced in the vicinity of device 10. Electronic devices such as wireless controllers with magnetic sensors that are in the vicinity of device 10 may use the magnetic field as a reference so that the wireless controllers can determine their orientation, position, and/or movement while being moved relative to device 10 to provide device 10 with input.

Consider, as an example, a handheld wireless controller that is used in controlling the operation of device 10. During operation, device 10 uses coil 54 to emit a magnetic field. As the handheld wireless controller is moved, the magnetic sensors of the controller can monitor the location of the controller and the movement of the controller relative to device 10 by monitoring the strength, orientation, and change to the strength and/or orientation of the magnetic field emitted by coil 54 as the controller is moved through the air by the user. The electronic device can then wirelessly transmit information on the location and orientation of the controller to device 10. In this way, a handheld controller, wearable controller, or other external accessory can be manipulated by a user to provide device 10 with air gestures, pointing input, steering input, and/or other user input.

Device 10 may have components such as optical components (e.g., optical sensors among sensors 16 of FIG. 2). These components may be mounted in any suitable location on head-mounted support structure 26 (e.g., on head strap 26B, on main housing portion 26M, etc.). Optical components and other components may face rearwardly (e.g., when mounted on the rear face of device 10), may face to the side (e.g., to the left or right), may face downwardly or upwardly, may face to the front of device 10 (e.g., when mounted on the front face of device 10), may be mounted so as to point in any combination of these directions (e.g., to the front, to the right, and downward) and/or may be mounted in other suitable orientations. In an illustrative configuration, at least some of the components of device 10 are mounted so as to face outwardly to the front (and optionally to the sides and/or up and down). For example, forward-facing cameras for pass-through video may be mounted on the left and right sides of the front of device 10 in a configuration in which the cameras diverge slightly along the horizontal dimension so that the fields of view of these cameras overlap somewhat while capturing a wide-angle image of the environment in front of device 10. The captured image may, if desired, include portions of the user's surroundings that are below, above, and to the sides of the area directly in front of device 10.

To help hide components such as optical components from view from the exterior of device 10, it may be desirable to cover some or all of the components with cosmetic covering structures. The covering structures may include transparent portions (e.g., optical component windows) that are characterized by sufficient optical transparency to allow overlapped optical components to operate satisfactorily. For example, an ambient light sensor may be covered with a layer that appears opaque to an external viewer to help hide the ambient light sensor from view, but that allows sufficient ambient light to pass to the ambient light sensor for the ambient light sensor to make a satisfactory ambient light measurement. As another example, an optical component that emits infrared light may be overlapped with a visibly opaque material that is transparent to infrared light.

In an illustrative configuration, optical components for device 10 may be mounted in inactive area IA of FIG. 3 and cosmetic covering structures may be formed in a ring shape overlapping the optical components in inactive area IA. Cosmetic covering structures may be formed from ink, polymer structures, structures that include metal, glass, other materials, and/or combinations of these materials. In an illustrative configuration, a cosmetic covering structure may be formed from a ring-shaped member having a footprint that matches the footprint of inactive area IA. If, for example, active area AA has left and right portions with teardrop shapes, the ring-shaped member may have curved edges that follow the curved periphery of the teardrop-shaped portions of active area AA. The ring-shaped member may be formed from one or more polymer structures (e.g., the ring-shaped member may be formed from a polymer ring). Because the ring-shaped member can help hide overlapped components from view, the ring-shaped member may sometimes be referred to as a shroud or ring-shaped shroud member. The outward appearance of the shroud or other cosmetic covering structures may be characterized by a neutral color (white, black, or gray) or a non-neutral color (e.g., blue, red, green, gold, rose gold, etc.).

Display 14F may, if desired, have a protective display cover layer. The cover layer may overlap active area AA and inactive area IA (e.g., the entire front surface of device 10 as viewed from direction 52 of FIG. 1 may be covered by the cover layer). The cover layer, which may sometimes be referred to as a housing wall or transparent housing wall, may have a rectangular outline, an outline with teardrop portions, an oval outline, or other shape with curved and/or straight edges.

The cover layer may be formed from a transparent material such as glass, polymer, transparent crystalline material such as sapphire, clear ceramic, other transparent materials, and/or combinations of these materials. As an example, a protective display cover layer for display 14F may be formed from safety glass (e.g., laminated glass that includes a clear glass layer with a laminated polymer film). Optional coating layers may be applied to the surfaces of the display cover layer. If desired, the display cover layer may be chemically strengthened (e.g., using an ion-exchange process to create an outer layer of material under compressive stress that resists scratching). In some configurations, the display cover layer may be formed from a stack of two or more layers of material (e.g., first and second structural glass layers, a rigid polymer layer coupled to a glass layer or another rigid polymer layer, etc.) to enhance the performance of the cover layer.

In active area AA, the display cover layer may overlap the pixels of display panel 14P. The display cover layer in active area AA is preferably transparent to allow viewing of images presented on display panel 14P. In inactive area IA, the display cover layer may overlap the ring-shaped shroud or other cosmetic covering structure. The shroud and/or other covering structures (e.g., opaque ink coatings on the inner surface of the display cover layer and/or structures) may be sufficiently opaque to help hide some or all of the optical components in inactive area IA from view. Windows may be provided in the shroud or other cosmetic covering structures to help ensure that the optical components that are overlapped by these structures operate satisfactorily. Windows may be formed from holes, may be formed from areas of the shroud or other cosmetic covering structures that have been locally thinned to enhance light transmission, may be formed from window members with desired light transmission properties that have been inserted into mating openings in the shroud, and/or may be formed from other shroud window structures.

In the example of FIG. 3, device 10 includes optical components such as optical components 60, 62, 64, 66, 68, 70, 72, 74, 76, 78, and 80 (as an example). Each of these optical components (e.g., optical sensors selected from among sensors 16 of FIG. 2, light-emitting devices, etc.) may be configured to detect light and, if desired to emit light (e.g., ultraviolet light, visible light, and/or infrared light).

In an illustrative configuration, optical component 60 may sense ambient light (e.g., visible ambient light). In particular, optical component 60 may have a photodetector that senses variations in ambient light intensity as a function of time. If, as an example, a user is operating in an environment with an artificial light source, the light source may emit light at a frequency associated with its source of wall power (e.g., alternating-current mains power at 60 Hz). The photodetector of component 60 may sense that the artificial light from the artificial light source is characterized by 60 Hz fluctuations in intensity. Control circuitry 12 can use this information to adjust a clock or other timing signal associated with the operation of image sensors in device 10 to help avoid undesired interference between the light source frequency and the frame rate or other frequency associated with image capture operations. Control circuitry 12 can also use measurements from component 60 to help identify the presence of artificial lighting and the type of artificial lighting that is present. In this way, control circuitry 12 can detect the presence of lights such as fluorescent lights or other lights with known non-ideal color characteristics and can make compensating color cast adjustments (e.g., white point adjustments) to color-sensitive components such as cameras and displays. Because optical component 60 may measure fluctuations in light intensity, component 60 may sometimes be referred to as a flicker sensor or ambient light frequency sensor.

Optical component 62 may be an ambient light sensor. The ambient light sensor may include one or more photodetectors. In a single-photodetector configuration, the ambient light sensor may be a monochrome sensor that measures ambient light intensity. In a multi-photodetector configuration, each photodetector may be overlapped by an optical filter that passes a different band of wavelengths (e.g., different visible and/or infrared passbands). The optical filter passbands may overlap at their edges. This allows component 62 to serve as a color ambient light sensor that measures both ambient light intensity and ambient light color (e.g., by measuring color coordinates for the ambient light). During operation of device 10, control circuitry 12 can take action based on measured ambient light intensity and color. As an example, the white point of a display or image sensor may be adjusted or other display or image sensor color adjustments may be made based on measured ambient light color. The intensity of a display may be adjusted based on light intensity. For example, the brightness of display 14F may be increased in bright ambient lighting conditions to enhance the visibility of the image on the display and the brightness of display 14F may be decreased in dim lighting conditions to conserve power. Image sensor operations and/or light source operations may also be adjusted based on ambient light readings.

The optical components in active area IA may also include components along the sides of device 10 such as components 80 and 64. Optical components 80 and 64 may be pose-tracking cameras that are used to help monitor the orientation and movement of device 10. Components 80 and 64 may be visible light cameras (and/or cameras that are sensitive at visible and infrared wavelengths) and may, in conjunction with an inertial measurement unit, form a visual inertial odometry (VIO) system.

Optical components 78 and 66 may be visible-light cameras that capture real-time images of the environment surrounding device 10. These cameras, which may sometimes be referred to as scene cameras or pass-through-video cameras, may capture moving images that are displayed in real time to displays 14R for viewing by the user when the user's eyes are located in eye boxes 34 at the rear of device 10. By displaying pass-through images (pass-through video) to the user in this way, the user may be provided with real-time information on the user's surroundings. If desired, virtual content (e.g., computer-generated images) may be overlaid over some of the pass-through video. Device 10 may also operate in a non-pass-through-video mode in which components 78 and 66 are turned off and the user is provided only with movie content, game content, and/or other virtual content that does not contain real-time real-world images.

Input-output devices 22 of device 10 may gather user input that is used in controlling the operation of device 10. As an example, a microphone in device 10 may gather voice commands. Buttons, touch sensors, force sensors, and other input devices may gather user input from a user's finger or other external object that is contacting device 10. In some configurations, it may be desirable to monitor a user's hand gestures or the motion of other user body parts. This allows the user's hand locations or other body part locations to be replicated in a game or other virtual environment and allows the user's hand motions to serve as hand gestures (air gestures) that control the operation of device 10. User input such as hand gesture input can be captured using cameras that operate at visible and infrared wavelengths such as tracking cameras (e.g., optical components 76 and 68). Tracking cameras such as these may also track fiducials and other recognizable features on controllers and other external accessories (additional devices 10 of system 8) during use of these controllers in controlling the operation of device 10. If desired, tracking cameras can help determine the position and orientation of a handheld controller or wearable controller that senses its location and orientation by measuring the magnetic field produced by coil 54. The use of tracking cameras may therefore help track hand motions and controller motions that are used in moving pointers and other virtual objects being displayed for a user and can otherwise assist in controlling the operation of device 10.

Tracking cameras may operate satisfactorily in the presence of sufficient ambient light (e.g., bright visible ambient lighting conditions). In dim environments, supplemental illumination may be provided by supplemental light sources such as supplemental infrared light sources (e.g., optical components 82 and 84). The infrared light sources may each include one or more light-emitting devices (light-emitting diodes or lasers) and may each be configured to provide fixed and/or steerable beams of infrared light that serve as supplemental illumination for the tracking cameras. If desired, the infrared light sources may be turned off in bright ambient lighting conditions and may be turned on in response to detection of dim ambient lighting (e.g., using the ambient light sensing capabilities of optical component 62).

Three-dimensional sensors in device 10 may be used to perform biometric identification operations (e.g., facial identification for authentication), may be used to determine the three-dimensional shapes of objects in the user's environment (e.g., to map the user's environment so that a matching virtual environment can be created for the user), and/or to otherwise gather three-dimensional content during operation of device 10. As an example, optical components 74 and 70 may be three-dimensional structured light image sensors. Each three-dimensional structured light image sensor may have one or more light sources that provide structured light (e.g., a dot projector that projects an array of infrared dots onto the environment, a structured light source that produces a grid of lines, or other structured light component that emits structured light). Each of the three-dimensional structured light image sensors may also include a flood illuminator (e.g., a light-emitting diode or laser that emits a wide beam of infrared light). Using flood illumination and structured light illumination, optical components 74 and 70 may capture facial images, images of objects in the environment surrounding device 10, etc.

Optical component 72 may be an infrared three-dimensional time-of-flight camera that uses time-of-flight measurements on emitted light to gather three-dimensional images of objects in the environment surrounding device 10. Component 72 may have a longer range and a narrower field of view than the three-dimensional structured light cameras of optical components 74 and 70. The operating range of component 72 may be 30 cm to 7 m, 60 cm to 6 m, 70 cm to 5 m, or other suitable operating range (as examples).

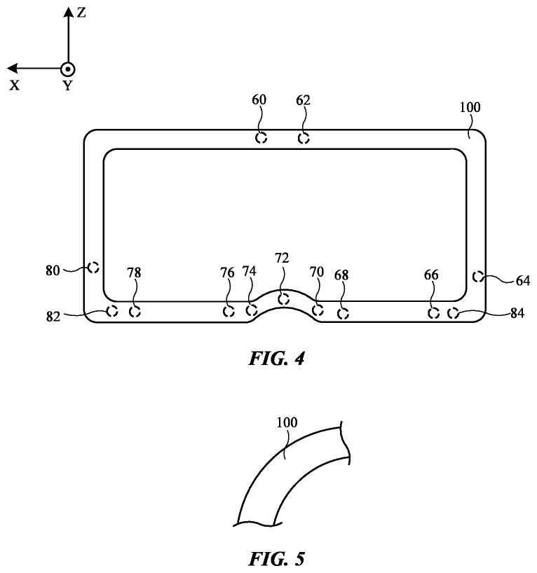

FIG. 4 is a front view of an illustrative ring-shaped cosmetic covering structure for device 10. Illustrative ring-shaped shroud 100 of FIG. 4 may be mounted under the inner surface of the display cover layer for display 14F in inactive area IA. This may help hide the optical components and other internal portions of device 10 from view from the exterior of device 10. Shroud 100 may be formed from one or more unbroken ring-shaped members and/or may be formed from multiple shroud segments that are attached using adhesive, fasteners, or other attachment structures. If desired, shroud 100 may be formed from multiple members that are sandwiched together along some or all of their lengths. In an illustrative configuration, which may sometimes be described herein as an example, shroud 100 may be formed from an inner piece (e.g., an inner full or partial ring), which may sometimes be referred to as an inner shroud member, shroud trim, or shroud trim member and may be formed from an outer piece or pieces (e.g., one or more strips of material or covering members, an full ring, one or more partial rings, etc.), which may sometimes be referred to as a shroud cover, canopy, or shroud canopy.

As shown in FIG. 4, shroud 100 may have optical component windows to accommodate components 60, 62, 64, 84, 66, 68, 70, 72, 74, 76, 78, 82, and 80. The optical component windows may be formed from through-hole openings in shroud 100, from recesses or other partial openings that do not pass entirely through shroud 100, from inserted optical window members in shroud through-hole openings, and/or from other shroud optical component window structures. Display 14F may have a display cover layer that has corresponding optical component windows (through-hole openings, recessed areas, inserted window members in through-hole openings, etc.) and/or that is formed from bulk material that has desired optical properties (e.g., a display cover layer formed from one or more layers of material such as glass and/or polymer with sufficient transparency at the operating wavelength range of the overlapped optical component to allow the optical component to operate satisfactorily through the cover layer without forming openings or other window structures in the cover layer).

Shroud 100 may have any suitable shape. For example, the outline of shroud 100 may be rectangular with rounded corners as shown in FIG. 4, may have teardrop shapes on the left and right sides of device 10, may have an oval outline, and/or may have other outlines with curved and/or straight edge segments. FIG. 5 is a front view of a portion of shroud 100 showing how the inner and outer edges of shroud 100 may be curved (e.g., to follow a teardrop shape). Shroud 100 may, if desired, have a peripheral edge that is curved along most or all of its length.

The width of shroud 100 may be constant along its length or shroud 100 may have portions that are wider than others. The thickness of shroud 100 (e.g., the dimension of shroud 100 into the page in the orientation of FIG. 4) may be smaller than the width of shroud 100 (the lateral dimension of shroud 100 within the page in the orientation of FIG. 4) or the thickness of the shroud may be equal to or greater than the width of the shroud. The shroud may have a two-dimensional shape (e.g., shroud 100 may have a planar shape that lies in the XZ plane in the example of FIG. 4) or may have a three-dimensional shape (e.g., a shape with a curved cross-sectional profile and/or a shape characterized by inner and/or outer surfaces of compound curvature). In an illustrative configuration, most or all of the inner and outer surfaces of shroud have a compound-curvature surface.

The optical components under inactive area IA may include components on the left and right sides of device 10 that operate in conjunction with each other. For example, scene cameras, tracking cameras, and/or structured light cameras in device 10 may be formed in pairs, each of which includes a left camera and a corresponding right camera. A left scene camera and a right scene camera may, as an example, operate together to capture overlapping images that provide device 10 with a wide field of view for gathering pass-through video. Left and right tracking cameras may operate together to track a user's hands or other external objects. Left and right structured light cameras or other three-dimensional cameras may be used together to capture three-dimensional images of the user's environment. To enhance performance of the left and right optical components in these types of paired component arrangements, it may be desirable to maintain accurate alignment between the left and right optical components. To help maintain left and right optical components on the respective left and right sides of device 10 in alignment with each other, device 10 may be provided with one or more housing structures that help support the optical components.

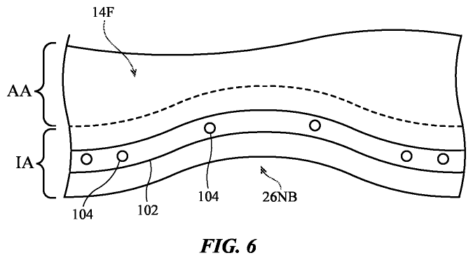

As shown in FIG. 6, for example, device 10 may be provided with an internal support structure such as bracket 102 that helps support optical components 104 on the left and right sides of device 10. Components 104 may be, for example, optical components of the type shown under inactive area IA of FIG. 3. Bracket 102 may be formed from stiff metal and/or other rigid materials (e.g., rigid polymer, carbon fiber composite material or other fiber-composite material, etc.). A nose-bridge recess in bracket 102 (e.g., in the portion of bracket 102 near nose-bridge portion 26NB) may help bracket 102 conform to the shape of the user's face. Bracket 102 may have an elongated strip shape that runs along a portion of the length of inactive area IA (e.g., on the lower edge of device 10).

Bracket 102 may be coupled to device 10 with attachment structures (adhesive, fasteners, press-fit connections, and/or other attachment mechanism) that allow bracket 102 to float with respect to the rest of housing portion 26M during a drop event. The stiffness of bracket 102 and the ability of bracket 102 to shift in position somewhat relative to other housing structures without deforming the shape of bracket 102 significantly may help hold components on the left and right sides of device 10 in alignment with each other during periods of excessive stress such as when device 10 experiences high stress during an unexpected drop event.

In the example of FIG. 6, bracket 102 is mounted under inactive area IA and has a nose bridge recess with a curved edge that is configured to accommodate a user's nose when device 10 is worn on a user's head. Bracket 102 may have other shapes, if desired. Components 104 may be attached to respective left and right sides of bracket 102 and/or other supporting structures in device 10 (e.g., shroud 100) using adhesive, fasteners, press fit connections, and/or other attachment structures.

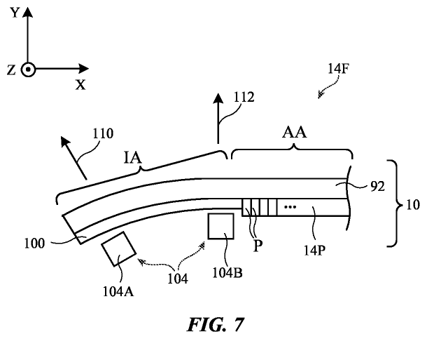

FIG. 7 is a cross-sectional top view of a portion of device 10. As shown in FIG. 7, shroud 100 may overlap one or more optical components 104 in inactive area IA. Inactive area IA may form a ring-shaped border that surrounds active area AA. Display 14F may have a display cover layer such as display cover layer 92. Layer 92 may be formed from glass, polymer, ceramic, crystalline material such as sapphire, other materials, and/or combinations of these materials. Layer 92 may include a single layer of material or multiple stacked layers of material. In active area AA, pixels P in display panel 14P display images that are viewable through display cover layer 92. Shroud 100 may be absent from active area AA (e.g., shroud may have a ring shape that surrounds an opening over panel 14P as shown in FIG. 7) or shroud 100 may optionally have a portion (sometimes referred to as a canopy or shroud structure) that overlaps display panel 14P. The canopy may be fully or partly transparent. In inactive area IA, shroud 100 overlaps components 104. Components 104 may be optical components that emit and/or detect light that passes through transparent portions of layer 92 and shroud 100 and/or through optical component windows formed from recesses, through-hole openings, window members, and/or other window structures in layer 92 and shroud 100.

Display cover layer 92 may include planar surfaces and/or curved surfaces. In an illustrative configuration, most or all of the inner and outer surfaces of display cover layer 92 have curvature.

The curved surfaces of display cover layer 92 may include curved surfaces that can be flattened into a plane without distortion (sometimes referred to as developable surfaces or curved surfaces without compound curvature). Surfaces such as these may, as an example overlap active area AA. The curved surfaces of display cover layer 92 may also include curved surfaces that are characterized by compound curvature (e.g., surfaces that can only be flattened into a plane with distortion, sometimes referred to as non-developable surfaces). Some or all portions of the inner and outer surfaces of display cover layer 92 in inactive area IA may, as an example, be characterized by compound curvature. This allows the periphery of display 14F to smoothly transition away from the active area and provides an attractive appearance and compact shape for device 10. The compound curvature of display cover layer 92 in inactive area IA may also facilitate placement of the optical components under inactive area IA in desired orientations. The inner and outer surfaces of display cover layer 92 in active area AA may have compound curvature, may be developable surfaces, or may include both developable surface areas and compound curvature areas.

Image data and other data gathered by optical components can be warped digitally to compensate for optical distortion associated with display cover layer 92. To help minimize optical distortion, one or more of the optical components may optionally be oriented in a direction that is parallel or close to parallel to the surface normal of the portion of the display cover layer surface that is overlapping the optical component.

Consider, as an example, optical components 104 of FIG. 7. As shown in FIG. 7, some optical components such as illustrative optical component 104B, which operates in direction 112, may face forward (e.g., direction 112 may be parallel to or nearly parallel to the Y axis of FIG. 7) in portions of display cover layer 92 where the surface normal of layer 92 is oriented parallel to the Y axis or close to parallel to the Y axis. Other optical components such as illustrative optical component 104A, which operates in direction 110, may be angled away from the forward direction by a non-zero angle (e.g., by an angle of at least 10°, at least 20°, less than 90°, less than 50°, or other suitable amount). Direction 110 may be parallel or closely parallel (e.g., aligned within 30°, within 20°, within 10° or other suitable amount) to the surface normal of the overlapping surface of display cover layer 92 and may lie in the XY plane of FIG. 7 or be angled out of the XY plane (e.g., by orienting component 104A so that direction 110 is angled upwards in the +Z direction or downwards in the −Z direction in addition to angling direction 110 away from the +Y direction as shown in FIG. 7).

In this type of arrangement, display cover layer 92 may have compound curvature in inactive area IA and shroud 100 may have a shape with a cross-sectional profile that mirrors that of display cover layer 92 in inactive area IA (e.g., the outer and/or inner surfaces of shroud 100 in inactive area IA may be compound-curvature surfaces). When components such as components 104A and 104B are mounted to shroud 100 and/or are otherwise supported by the support structures of device 10 to operate through shroud 100 and display cover layer 92, the curved shape of display cover layer 92 and shroud 100 may help allow these components to face in desired orientations (e.g., in a forward direction for components such as component 104B or angled away from the forward direction for components such as component 104A).

As an example, optical components that are mounted to the left and right sides of nose bridge portion 26NB may be oriented respectively somewhat to the left and somewhat to the right of the +Y forward direction (e.g., to ensure an adequate angle-of-view for a pair of cameras). As another example, the curved shape of display cover layer 92 and shroud 100 along the lower edge of device 10 may allow the components in this portion to point somewhat downward out of the XY plane, which may help orient cameras such as tracking cameras towards the user's hands.

Display panel 14P may be a flexible display such as a flexible organic light-emitting diode display with a flexible substrate or a light-emitting diode display formed from crystalline semiconductor light-emitting diode dies mounted on a flexible substrate. This allows display panel 14P and the pixels of panel 14P that form active area AA to be bent about a bend axis that runs parallel to vertical axis Z, thereby helping to wrap display 14F and housing portion 26M about the curved surface of the user's face. If desired, display panel 14P may be a lenticular display configured to display three-dimensional images (e.g., an autostereoscopic display having a series of parallel lenticular lenses, each of which overlaps a respective group of multiple columns of pixels).

The outer and inner surfaces of display cover layer 92 may have the same shape (e.g., these surfaces may be parallel to each other) or the outer surface and inner surfaces may have different shapes. In arrangements in which display panel 14P of display 14F is flexible, it may be desirable to configure the inner surface of display cover layer 92 in active area AA to exhibit a bent surface shape that matches the bent outwardly-facing surface of display panel 14P (e.g., the inner and, if desired, the outer surface of display cover layer 92 in active area AA may be developable surfaces without compound curvature to match the developable outward-facing surface of display panel 14P).

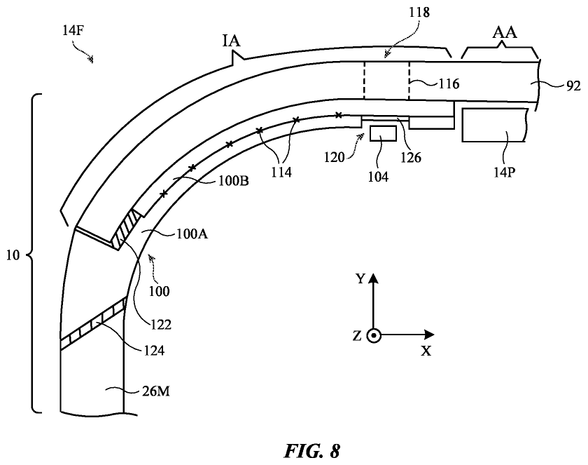

Shroud 100 and display cover layer 92 may be attached to main housing portion 26M using adhesive, screws and other fasteners, press-fit connections, and/or other attachment mechanisms. An illustrative configuration in which shroud 100 and cover layer 92 are attached to forward-facing edge of a housing wall in main housing portion 26M using adhesive is shown in FIG. 8. In the example of FIG. 8, shroud 100 has an inner shroud member such as shroud trim 100A and has a corresponding outer shroud member such as shroud canopy 100B. Shroud trim 100A and shroud canopy 100B may be formed from metal, polymer, ceramic, glass, other materials, and/or combinations of these materials. In an illustrative example, shroud trim 100A is formed from black polymer or other dark material and shroud canopy 100B is formed from clear polymer. The outer surface of shroud canopy 100B may be smooth to provide shroud 100 with a cosmetically attractive appearance.

A layer of pressure sensitive adhesive (see, e.g., adhesive 114) may be used in attaching canopy 100B to trim 100A. Adhesive may also be used in attaching cover layer 92 and shroud 100 to housing portion 26M. As shown in FIG. 8, for example, a first adhesive such as adhesive 122 may be used to attach display cover layer 92 to shroud 100 (e.g., to a ledge in shroud trim 100A). A second adhesive such as adhesive 124 may, in turn, be used to attach shroud 100 (e.g., shroud trim 100A) to an adjacent lip of a wall in main housing portion 26M.

In some configurations, adhesives 122 and 124 may be formed from the same type of material. In an illustrative configuration, adhesives 122 and 124 are different. Housing portion 26M may have a wall with a lip shape that creates a shearing force on adhesive 124 as display 14F is attached to housing portion 26M by pressing display 14F against housing portion 26M in the −Y direction. In this type of scenario, it may be desirable to form adhesive 124 from an adhesive that can bond satisfactorily in the presence of shear forces such as a molten hot melt glue (thermoplastic adhesive) or other liquid adhesive rather than pressure sensitive adhesive. Adhesive 124 may, if desired, be exposed to a curing agent (ultraviolet light, moisture, etc.) before display 14F is assembled into housing 26M.

It may be desirable to repair device 10. For example, if a user exposes display 14F to excessive force during a drop event, it may be desirable to replace display 14F with a new display. This can be accomplished by heating adhesive 124 to loosen the adhesive bond formed by adhesive 124. To help prevent display cover layer 92 from detaching from shroud 100 while softening adhesive 124 with heat, adhesive 122 may be provided with a higher-temperature softening point than adhesive 124 (e.g., adhesive 122 may be a two-part hot melt glue with a higher melting point than adhesive 124).

Optical components that are overlapped by display cover layer 92 and shroud 100 in inactive area IA may transmit and/or receive light through shroud 100 and display cover layer 92. Layer 92 may be formed from laminated glass or other clear material that allows light for each overlapped optical component 104 to pass through layer 92. If desired, a partial recess or a through-hole opening may be formed in the portion of layer 92. An optional optical component window member 116 may then be inserted within layer 92 (e.g., in window region 118). As an example, layer 92 may be formed from one or more layers of glass and/or polymer and may be characterized by a first level of light transmission at operating wavelength(s) for component 104, whereas window member 116 may be formed from polymer, glass, and/or other materials that are characterized by a second level of light transmission at the operating wavelength(s) that is greater than the first level of light transmission. In other illustrative arrangements, no window member is inserted in layer 92 (e.g., optional window member 116 of FIG. 8 can be omitted when layer 92 alone is sufficiently transparent to pass light for component 104).

Shroud 100 may be provided with an optical component window in region 118 to accommodate overlapped optical component 104. Component 104 may operate at ultraviolet light wavelengths, visible light wavelengths, and/or infrared light wavelengths. To accommodate component 104 in the example of FIG. 8, shroud trim 100A has been provided with a through-hole opening such as opening 120, whereas shroud canopy 100B has no openings in region 118. This effectively forms a window recess in shroud 100 in alignment with components 104. Trim 100A may be formed from black polymer or other light-absorbing material, so the formation of opening 120 in trim 100A may help ensure that sufficiently light may pass through region 118 to allow component 104 to operate satisfactorily. The portion of canopy 100B that overlaps opening 120 may be transparent (e.g., clear polymer).

To help hide component 104 from view, the inner surface of shroud canopy 100B of FIG. 8 has been covered with coating 126. Coating 126 may be used to provide region 118 with a desired outward appearance and optical properties that ensure that component 104 can operate satisfactorily. Coating 126 may be a thin-film-interference filter formed from a stack of thin-film dielectric layers of alternating refractive index values (with indices and thicknesses selected to create a desired transmission spectrum and a desired reflection spectrum for the filter), may be a layer of ink (e.g., a polymer layer including dye, pigment, and/or other colorant), and/or may be any other suitable coating with desired optical properties.

Consider, as an example, a scenario in which component 104 transmits and/or receives infrared light. In this type of arrangement, coating 126 may be opaque at visible wavelengths and transparent at infrared wavelengths. This helps to hide component 104 from view from the exterior of device 10 while allowing infrared light associated with the operation of component 104 to pass through shroud 100 and layer 92.

As another example, consider a scenario in which component 104 is an ambient light sensor. In this configuration, coating 126 may exhibit a visible light transmission of 1-8% (as an example). This may allow sufficient visible ambient light to reach the ambient light sensor for the ambient light sensor to make an ambient light reading. At the same time, the transmission of coating 126 may be sufficiently low that coating 126 helps reduce the visibility of component 104 from the exterior of device 10.

As these examples demonstrate, regions of display 14F that overlap optical components such as component 104 of FIG. 8 may be provided with optical component window structures in layer 92 and/or shroud 100 that help accommodate the optical component.

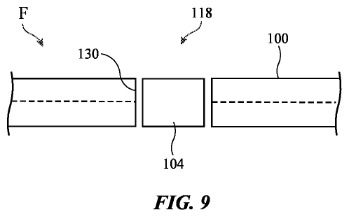

If desired, shroud 100 may be provided with a through-hole opening to accommodate an overlapped optical component. As shown in FIG. 9, for example, shroud 100 may contain one or more sublayers (e.g., a trim, a canopy, and/or other layers). Through-hole opening 130 may pass from the inner surface of shroud 100 to the outer surface of shroud 100. Opening 130 may be aligned with optical component 104. Component 104 may be mounted behind opening 130 and/or may be partly or fully receive within opening 130 as shown in FIG. 9. This allows light to be emitted and/or received by component 104 without being blocked by shroud 100.

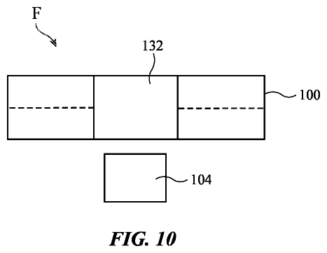

In the illustrative configuration of FIG. 10, shroud 100 also contains one more sublayers (e.g., a trim, a canopy, and/or other layers). As shown in FIG. 10, a through-hole opening may formed in shroud 100 in alignment with optical component 104 and may be filled with optical component window member 132 (e.g., a glass or polymer member or a window structure formed from other material and/or combinations of these materials). Optical component window member 132 has optical characteristics (e.g., light transmission, reflection, absorption, haze, etc.) that allow component 104 to transmit and/or receive light satisfactorily through region 118. As an example, member 130 may be formed from glass that is transparent to infrared light and that is opaque or transparent to visible light.

As described in connection with FIGS. 3 and 4, there may be numerous optical components such as component 104 in inactive area IA. Each optical component may potentially have a different type of optical component window structure in shroud 100 and/or layer 92 to accommodate that component. For example, some areas of shroud 100 may have openings that receive components as described in connection with FIG. 9, other areas of shroud 100 may have inserted optical window member such as member 132 of FIG. 10, and/or other areas of shroud 100 may have partial shroud openings (e.g., non-through-hole recesses) such as opening 120 of FIG. 8 (which may optionally be covered with a layer such as coating 126 to modify the optical properties of shroud 100).

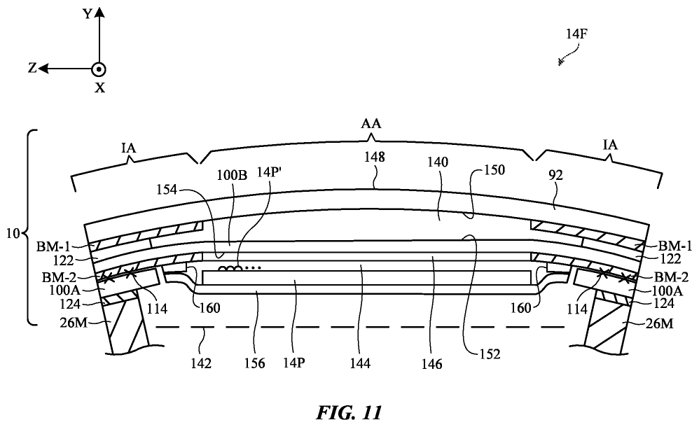

FIG. 11 is a cross-sectional side view of a portion of a head-mounted device with a fully or partly transparent shroud covering the front face of the device. As shown in FIG. 11, head-mounted device 10 may include display panel 14P for forward-facing display 14. Panel 14P may be a lenticular display (e.g., an autostereoscopic display with lenticular lenses 14P′ configured to display three-dimensional images for a user).

In the arrangement of FIG. 11, display cover layer 92 has inner and outer surfaces with compound curvature in inactive area IA (e.g., a ring-shaped area running along the periphery of layer 92). The inner and outer surfaces of display cover layer 92 in active area AA may also have compound curvature or one or both of these surfaces may be developable surfaces. In the example of FIG. 11, the inner and outer surfaces of layer 92 have compound curvature in both inactive area IA and active area AA (e.g., these surfaces may be free of any developable surfaces), which may help provide device 10 with an attractive appearance.

The shroud of device 10 of FIG. 11 includes a shroud trim 100A and shroud canopy 100B. Trim 100A may have a ring shape and may extend around the periphery of display 14. Canopy 100B, which may be formed from a material such as polymer, may have an outline equal to or nearly equal to that of display cover layer 92 and may cover substantially the entire front face of device 10. With this type of arrangement, shroud canopy 100B overlaps all of display panel 14P. The polymer that makes up canopy 100B may have a bulk tint (e.g., a colorant such as dye and/or pigment that provides canopy 100B with a desired optical transmission characteristic). For example, canopy 100B may be tinted so that canopy 100B exhibits a visible light transmission of 30-80%, at least 20%, at least 40%, less than 95%, less than 90%, less than 85%, less than 75%, 60%, or other suitable amount. By configuring canopy 10B to exhibit partial light transmission (e.g., 30-80% or other suitable value), canopy 100B may help visually hide internal components such as lenses 14P′ and other structures of display 14P from view (e.g., when display 14P is not in use).

The inner surface of canopy 100B may also be provided with an optical layer such as optical layer (optical film) 146. Layer 146 may have texture and/or light-scattering particles that create haze. The haze may help hide the structures of display panel 14P from view from the exterior of device 10. Layer 146 may also have microlouvers or other features that help suppress off-axis light transmission (e.g., layer 146 may have privacy structures that reduce light transmission for light rays that are not parallel to the Y axis). Because layer 146 may contain haze and/or privacy structures, layer 146 may sometimes be referred to as a privacy layer, a haze layer, and/or a privacy and haze layer.

In an illustrative configuration, layer 146 may have a flexible substrate layer covered with a hazy coating. The hazy coating may be a pad-printed polymer coating that contains embedded light-scattering particles (e.g., inorganic light-scattering particles such as titanium oxide particles, etc.). The flexible substrate layer may be a privacy film such as a microlouver film or other privacy layer that prevents off-axis (away from the Y axis) viewing of display panel 14P).

Haze for layer 146 may be provided using any suitable haze structures (e.g., a coating of hazy polymer having a thickness of 3-10 microns on a flexible privacy film or other substrate, a laminated hazy film, or other layer that exhibits 3%-40% haze or other suitable value, sometimes referred to as a haze coating). Haze may be provided by embedded light-scattering particles and/or surface texture (e.g., texture in layer 146 or optionally texture on the surface of canopy 100B). The haze provided by the hazy coating of layer 146 and/or other haze structures is preferably provided sufficiently close to display 14P that the resolution of display 14P is not significantly affected. At the same time, the presence of the haze (e.g., the hazy coating of layer 146) may help hide lenses and other structures in layer 14P from view when not in use.

Device 10 may have an air gap between display panel 14P and canopy 100B (e.g., an air gap such as air gap 144 may be present between the inwardly facing side of canopy 100B and any coatings and/or films on this side of canopy 100B such as haze layer 146 and the opposing upper surface of display panel 14P (and lenses 14P′ and the pixels on panel 14P). The presence of air gap 144 may help ensure that lenses 14P′ operate satisfactorily. Bracket 156 may help support display panel 14P.

To help hide internal components from view, an opaque masking layer such as layer BM-1 may be formed on the inner surface of display cover layer 92 in inactive area IA. Adhesive 122 may attach layer 92 to the edge of canopy 100B. Additional opaque masing material (see, e.g., canopy opaque masking layer BM-2) may be formed on the inner surface of canopy 100B in inactive area IA. Adhesive 114 may be used to attach shroud trim 100A to shroud canopy 100B. Adhesive 124 may be used to attach shroud trim 100A to housing portion 26M. Adhesive 160 may be used to attach bracket 156 (which is attached with adhesive to the rear of panel 14P) to canopy 100B.

In the example of FIG. 11, outer surface 148 and inner surface 150 of display cover layer 92 have compound curvature in inactive area IA and in active area AA. Outer surface 152 and opposing inner surface 154 of shroud canopy 100B may have matching compound curvature in inactive area IA. In active area AA, outer surface 152 and inner surface 154 of shroud canopy 100B may be developable surfaces (e.g., surfaces without compound curvature that exhibit a curved cross-sectional profile that bends about a single bend axis such as axis 142). Axis 142 is an axis that runs parallel to the Z axis in this example. Display panel 14P may exhibit the same amount of bending about axis 142 and may also be characterized by a developable surface (e.g., the pixel array on the outer surface of panel 14P may have a developable surface).

The amount of bending of canopy 100B and the corresponding amount of bending of display panel 14P about axis 142 may be selected to help device 10 conform to the curved shape of a user's face.

In the illustrative configuration of FIG. 11, canopy 100B does not have any areas of compound curvature that overlap display panel 14P. Rather, the portion of canopy 100B that overlaps panel 14P has inner and outer developable surfaces. If desired, one or both of surfaces 152 and 154 may have compound curvature. For example, outer surface 152 may have compound curvature and may be configured to establish a uniform thickness for air gap 140 under some or all of inner surface 150 of layer 92. In the example of FIG. 11, there is an air gap 140 of uneven thickness between layer 92 and canopy 100B.

Bracket 156 may be formed from a metal sheet or other support structure and may be characterized by inner and outer surfaces that are developable surfaces (e.g., surfaces that bend about axis 142 and that do not contain areas of compound curvature). By avoiding compound curvature in the structures that support and immediately overlap display panel 14P, display panel 14P may be formed from a bent flexible substrate such as a polyimide substrate that bends about axis 142 without risk of creating wrinkles or other artifacts of the type that might be introduced if panel 14P had areas of compound curvature.

The shroud and other structures of device 10 of FIG. 11 (e.g., the opaque masking layer coatings such as layers BM-1 and BM-2 which may be, for example, black ink layers) may be configured to form optical windows for optical components 104.

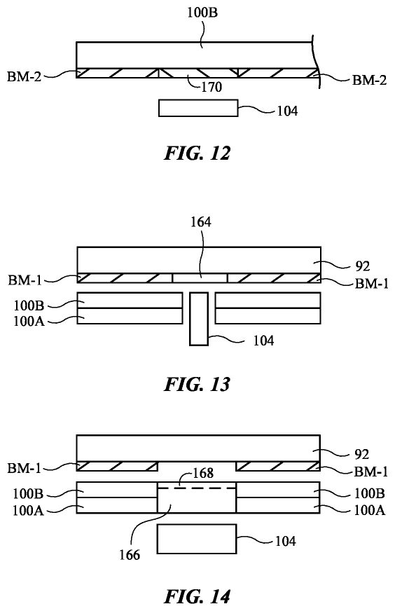

FIG. 12 shows how opaque masking layer BM-2 on canopy 100B may have a window opening that is filled with a coating layer such as coating 170. Optical component 104 (e.g., a flicker sensor, an ambient light sensor, and/or other photodetector) may be aligned with the window opening. A transparent canopy portion may overlap this window opening or a canopy opening may overlap this window opening. Layer BM-2 may be opaque, which helps prevent internal components in device 10 from being viewed from the exterior of device 10. The presence of the opening in layer BM-2 allows optical component 104 to operate satisfactorily (e.g., to receive and measure ambient light). Coating 170 may be configured to allow component 104 to operate, while helping to visually hide component 104. As an example, coating 170 may be formed from a layer of ink with a visible light transmission of 2-25%, at least 1%, at least 2%, at least 4%, less than 80%, less than 30%, or other suitable amount, whereas layer BM-2 may have a visible transmission of less than 2%, less than 1%, or less than 0.5% (as examples).

FIG. 13 is a cross-sectional side view of another illustrative head-mounted device optical component mounting arrangement. The arrangement of FIG. 13 uses shroud through-hole openings in trim 100A and canopy 100B. These through-hole openings are aligned with an opening in display opaque masking layer BM-1 (and are optionally aligned with a corresponding opening in canopy opaque masking layer BM-2). An optional coating layer such as layer 164 may cover the optical window formed from these openings. Layer 164 and the other openings of FIG. 14 may be aligned with optical component 104, which may be mounted behind the shroud and/or which may have portions protruding into the through-hole openings of the shroud. In a first illustrative configuration, component 104 of FIG. 13 is an infrared illuminator (e.g., an infrared light-emitting diode). In this type of arrangement, coating layer 164 may be formed from a layer of ink, a thin-film interference filter, or other filter layer that blocks visible light and that is transparent to infrared light (e.g., a visible-light-blocking-and-infrared-light-transmitting filter layer). In a second illustrative configuration, component 104 of FIG. 13 is a camera (e.g., a visible pass-through camera, an infrared camera, and/or other camera operating at visible and/or infrared wavelengths). In this arrangement, coating 164 may be omitted (to pass visible and/or infrared light), may be configured to form an antireflection coating, and/or may otherwise be configured to operate with the camera.

FIG. 14 is a cross-sectional side view of an illustrative head-mounted device optical component mounting arrangement with an optical component window formed from a transparent window member. Transparent window member 166 (e.g., a layer of glass or polymer) may be mounted in through-hole openings in trim 100A and canopy 100B and may be aligned with optical component 104 and an opening in opaque masking layer BM-1 on layer 92 (and, if desired, may be aligned with an opening in opaque masking layer BM-2 on canopy 100B). Filter coating 168 may be provided on window member 166. In an illustrative configuration, component 104 of FIG. 14 is a three-dimensional camera such as a time-of-flight camera or a structured light camera and may operate at infrared wavelengths. Filter 168 in this type of arrangement may be transparent to infrared light and may be transparent to visible light or may be opaque to visible light (e.g., filter 168 may be an infrared-light-transparent-and-visible-light-blocking filter). Filter coating 168 may be formed from ink, from a thin-film interference filter, or other filter structures.

The presence of window member 166, which may be configured to exhibit relatively small amounts of optical distortion, may help enhance the optical performance of component 104. If desired, optical-component-compatible surface areas for an optical component window for component 104 may be formed directly in canopy 100B (e.g., so that canopy 100B may overlap component 104 without forming a through-hole opening in canopy 100B).

In accordance with an embodiment, a head-mounted device is provided that includes a head-mounted support structure; a first display and a first lens that are supported by the head-mounted support structure and that are configured to provide a first image to a first eye box; a second display and a second lens that are supported by the head-mounted support structure and that are configured to provide a second image to a second eye box; a forward-facing display supported on a front side of the head-mounted support structure, the forward facing display has an active area in which a third image is displayed and has a ring-shaped inactive area surrounding the active area that does not display images and the forward-facing display has a display cover layer that overlaps the active area and the inactive area; an optical component in the inactive area; and a covering structure that overlaps the inactive area under the display cover layer.

In accordance with another embodiment, the covering structure includes a shroud that has a shroud trim and that has a shroud canopy, the shroud canopy includes clear polymer, the shroud trim includes dark polymer, the shroud canopy is attached to the shroud trim with adhesive, and the head-mounted device includes a coating on an inner surface of the shroud canopy overlapping the optical component.

In accordance with another embodiment, the covering structure includes a ring-shaped polymer structure that surrounds the active area.

In accordance with another embodiment, the ring-shaped polymer structure has a through-hole opening aligned with the optical component.

In accordance with another embodiment, the ring-shaped polymer structure has an opening, the head-mounted device includes a glass member in the opening that is aligned with the optical component.

In accordance with another embodiment, the ring-shaped polymer structure has a recess aligned with the optical component.

In accordance with another embodiment, the ring-shaped polymer structure includes first and second polymer members attached with adhesive and the recess is formed by a through-hole in the first polymer member.

In accordance with another embodiment, the second polymer member includes clear polymer that overlaps the through-hole in the first polymer member.

In accordance with another embodiment, the head-mounted device includes a coating on an inner surface of the clear polymer that overlaps the through-hole opening.

In accordance with another embodiment, the first polymer member includes black polymer.

In accordance with another embodiment, the head-mounted device includes a first adhesive layer configured to attach the display cover layer to the ring-shaped polymer structure; and a second adhesive with a melting point lower than the first adhesive layer, the second adhesive layer is configured to attach the ring-shaped polymer structure to the head-mounted support structure.

In accordance with another embodiment, the covering structure includes a polymer layer that is separated from the display cover layer by an air gap, the polymer layer has a surface with compound-curvature overlapping the inactive area and has a developable surface overlapping the active area.

In accordance with an embodiment, a head-mounted device is provided that includes a head-mounted support structure; rear-facing displays supported by the head-mounted support structure that are configured to provide visual content to eye boxes at a rear side of the head-mounted support structure; a publicly viewable forward-facing display supported on a front side of the head-mounted support structure, the publicly viewable forward-facing display has an active area containing pixels configured to display an image and has a ring-shaped inactive area without pixels that surrounds the active area; and a display cover layer for the forward-facing display, the display cover layer overlaps the active area and overlaps the ring-shaped inactive area; a ring-shaped shroud member that is overlapped by the display cover layer in the inactive area and that surrounds the active area; and optical components overlapped by the ring-shaped shroud member.

In accordance with another embodiment, the optical components include a flicker sensor and an ambient light sensor.

In accordance with another embodiment, the head-mounted device includes a shroud canopy coupled to the ring-shaped shroud member, the flicker sensor and ambient light sensor are aligned with an opening in the ring-shaped shroud member and are covered by the shroud canopy.

In accordance with another embodiment, the ring-shaped shroud member and the shroud canopy have through-hole openings that are aligned with the optical components.

In accordance with another embodiment, the optical components include cameras.

In accordance with another embodiment, the optical components include an ambient light sensor, the ring-shaped shroud member has a recess with a coating through which the ambient light sensor measures ambient light.

In accordance with another embodiment, the head-mounted device includes a bracket under a portion of the ring-shaped shroud member, the display cover layer has a nose bridge recess and a first of the optical components is attached to the bracket on one side of the nose bridge recess and a second of the optical components is attached to the bracket on an opposing side of the nose bridge recess.

In accordance with another embodiment, the ring-shaped shroud member includes a portion that is transparent at a wavelength and the optical components include an optical component that receives light at the wavelength that has passed through the portion of the ring-shaped shroud member.

In accordance with another embodiment, the ring-shaped shroud member has a surface with compound curvature.

In accordance with an embodiment, a head-mounted device is provided that includes a head-mounted support structure; a left lens on a left side of the head-mounted support structure; a right lens on the right side of the head-mounted support structure; left and right displays configured to provide respective left and right rear images viewable from left and right eye boxes through the left and right lenses; a publicly viewable display on the head-mounted support structure facing away from the left and right displays, the publicly viewable display has pixels configured to display a publicly viewable image and has an inactive ring-shaped border surrounding the pixels; a display cover layer covering the publicly viewable display; and a polymer layer that overlaps the pixels and that is between the pixels and the display cover layer.

In accordance with another embodiment, the polymer layer is separated from the pixels by an air gap.

In accordance with another embodiment, the display cover layer is separated from the polymer layer by an air gap.

In accordance with another embodiment, the display cover layer has inner and outer surfaces of compound curvature overlapping the pixels.

In accordance with another embodiment, the polymer layer has a developable surface that overlaps the pixels.

In accordance with another embodiment, the head-mounted device includes optical components in the inactive ring-shaped border.

In accordance with another embodiment, the optical components include cameras, the display cover layer has a surface with compound curvature in the inactive ring-shaped area, and the cameras are configured to capture images in different respective directions through respective portions of the surface of compound curvature.

In accordance with another embodiment, the polymer layer is configured to exhibit visible light transmission of 30-80%.

In accordance with another embodiment, the polymer layer has a hazy coating overlapping the pixels.

The foregoing is merely illustrative and various modifications can be made to the described embodiments. The foregoing embodiments may be implemented individually or in any combination.

What is claimed is:

1. A head-mounted device, comprising:
a head-mounted support structure;
a first display and a first lens that are supported by the head-mounted support structure and that are configured to provide a first image to a first eye box;
a second display and a second lens that are supported by the head-mounted support structure and that are configured to provide a second image to a second eye box;
a forward-facing display supported on a front side of the head-mounted support structure, wherein the forward facing display has an active area in which a third image is displayed and has a ring-shaped inactive area surrounding the active area that does not display images and wherein the forward-facing display has a display cover layer that overlaps the active area and the inactive area;
an optical component in the inactive area; and
a covering structure that overlaps the inactive area under the display cover layer.

2. The head-mounted device defined in claim 1 wherein the covering structure comprises a shroud that has a shroud trim and that has a shroud canopy, wherein the shroud canopy comprises clear polymer, wherein the shroud trim comprises dark polymer, wherein the shroud canopy is attached to the shroud trim with adhesive, and wherein the head-mounted device further comprises a coating on an inner surface of the shroud canopy overlapping the optical component.

3. The head-mounted deice defined in claim 1 wherein the covering structure comprises a ring-shaped polymer structure that surrounds the active area.

4. The head-mounted device defined in claim 3 wherein the ring-shaped polymer structure has a through-hole opening aligned with the optical component.

5. The head-mounted device defined in claim 3 wherein the ring-shaped polymer structure has an opening, the head-mounted device further comprising a glass member in the opening that is aligned with the optical component.

6. The head-mounted device defined in claim 3 wherein the ring-shaped polymer structure has a recess aligned with the optical component.

7. The head-mounted device defined in claim 6 wherein the ring-shaped polymer structure comprises first and second polymer members attached with adhesive and wherein the recess is formed by a through-hole in the first polymer member.

8. The head-mounted device defined in claim 7 wherein the second polymer member comprises clear polymer that overlaps the through-hole in the first polymer member.

9. The head-mounted device defined in claim 8 further comprising a coating on an inner surface of the clear polymer that overlaps the through-hole opening.

10. The head-mounted device defined in claim 9 wherein the first polymer member comprises black polymer.

11. The head-mounted device defined in claim 3 further comprising:
a first adhesive layer configured to attach the display cover layer to the ring-shaped polymer structure; and
a second adhesive with a melting point lower than the first adhesive layer, wherein the second adhesive layer is configured to attach the ring-shaped polymer structure to the head-mounted support structure.

12. The head-mounted device defined in claim 1 wherein the covering structure comprises a polymer layer that is separated from the display cover layer by an air gap, wherein the polymer layer has a surface with compound-curvature overlapping the inactive area and has a developable surface overlapping the active area.

13. A head-mounted device, comprising:
a head-mounted support structure;
rear-facing displays supported by the head-mounted support structure that are configured to provide visual content to eye boxes at a rear side of the head-mounted support structure;
a publicly viewable forward-facing display supported on a front side of the head-mounted support structure, wherein the publicly viewable forward-facing display has an active area containing pixels configured to display an image and has a ring-shaped inactive area without pixels that surrounds the active area; and
a display cover layer for the forward-facing display, wherein the display cover layer overlaps the active area and overlaps the ring-shaped inactive area;
a ring-shaped shroud member that is overlapped by the display cover layer in the inactive area and that surrounds the active area; and
optical components overlapped by the ring-shaped shroud member.

14. The head-mounted device defined in claim 13 wherein the optical components comprise a flicker sensor and an ambient light sensor.

15. The head-mounted device defined in claim 14 further comprising a shroud canopy coupled to the ring-shaped shroud member, wherein the flicker sensor and ambient light sensor are aligned with an opening in the ring-shaped shroud member and are covered by the shroud canopy.

16. The head-mounted device defined in claim 13 wherein the ring-shaped shroud member and the shroud canopy have through-hole openings that are aligned with the optical components.

17. The head-mounted device defined in claim 16 wherein the optical components comprise cameras.

18. The head-mounted device defined in claim 13 wherein the optical components comprise an ambient light sensor, wherein the ring-shaped shroud member has a recess with a coating through which the ambient light sensor measures ambient light.

19. The head-mounted device defined in claim 13 further comprising a bracket under a portion of the ring-shaped shroud member, wherein the display cover layer has a nose bridge recess and wherein a first of the optical components is attached to the bracket on one side of the nose bridge recess and wherein a second of the optical components is attached to the bracket on an opposing side of the nose bridge recess.

20. The head-mounted device defined in claim 13 wherein the ring-shaped shroud member comprises a portion that is transparent at a wavelength and wherein the optical components comprise an optical component that receives light at the wavelength that has passed through the portion of the ring-shaped shroud member.

21. The head-mounted device defined in claim 13 wherein the ring-shaped shroud member has a surface with compound curvature.

22. A head-mounted device, comprising:
a head-mounted support structure;
a left lens on a left side of the head-mounted support structure;
a right lens on the right side of the head-mounted support structure;
left and right displays configured to provide respective left and right rear images viewable from left and right eye boxes through the left and right lenses;
a publicly viewable display on the head-mounted support structure facing away from the left and right displays, wherein the publicly viewable display has pixels configured to display a publicly viewable image and has an inactive ring-shaped border surrounding the pixels;
a display cover layer covering the publicly viewable display; and
a polymer layer that overlaps the pixels and that is between the pixels and the display cover layer.

23. The head-mounted device defined in claim 22 wherein the polymer layer is separated from the pixels by an air gap.

24. The head-mounted device defined in claim 23 wherein the display cover layer is separated from the polymer layer by an air gap.

25. The head-mounted device defined in claim 24 wherein the display cover layer has inner and outer surfaces of compound curvature overlapping the pixels.

26. The head-mounted device defined in claim 25 wherein the polymer layer has a developable surface that overlaps the pixels.

27. The head-mounted device defined in claim 22 further comprising optical components in the inactive ring-shaped border.

28. The head-mounted device defined in claim 27 wherein the optical components comprise cameras, wherein the display cover layer has a surface with compound curvature in the inactive ring-shaped area, and wherein the cameras are configured to capture images in different respective directions through respective portions of the surface of compound curvature.

29. The head-mounted device defined in claim 22 wherein the polymer layer is configured to exhibit visible light transmission of 30-80%.

30. The head-mounted device defined in claim 22 wherein the polymer layer has a hazy coating overlapping the pixels.
